(19) United States
(12) Patent Application Publication
(10) Pub. No.: US 2002/0109316 A1
(43) Pub. Date: Aug. 15, 2002

(54) Apparatus for the vertical transport and storage of tables

(76) Inventor: Robert K. Cassidy, Palm Springs, CA (US)

Correspondence Address: MICHAEL W. STARKWEATHER, JONES, WALDO, HOLBROOK & McDONOUGH, 1500 Wells Fargo Plaza, 170 South Main Street, Salt Lake City, UT, 84101-1644, US

(21) Appl. No.: 09/781,834

(22) Filed: Feb. 12, 2001

(51) Int. Cl. B62D 39/00

(52) U.S. Cl. 280/33.998

(57) ABSTRACT

A round table cart for moving round tables along the ground. Uniquely, the invention has a first and second side support, each having a bottom, top, front and rear location. There is a ramp, connected between the first and second side supports at the bottom and front location. A pair of pivot wheels are connected to the first and second side supports near the rear location. A support bar, coupled between the first and second side supports proximate the ramp. A pair of swivel wheels, connected to the first and second side supports at that location. The table cart specifically is designed to have a first position that positions the ramp and the pair of pivot wheels on the ground, while maintaining the pair of swivel wheels off of the ground so that a round table can be loaded onto the round table cart. A second position of the cart comprises a position where the ramp is above the ground and the pair of pivot and swivel wheels are positioned upon the ground for easy movement of the round table cart across the ground.

### THE FIELD OF THE INVENTION

The present invention relates generally to transport equipment. More particularly, the present invention relates to a cart that allows for the transportation and the storage of round tables that are in a vertical storage position.

### BACKGROUND OF THE INVENTION

Typically, many social functions require the use of a large number of tables for dining or other activities. Often, social halls include closets or other facilities for the storage of these tables. These closets may, for example, store the tables either lying on a cart in a horizontal position, or standing vertically in a rack. In either situation, it is often a laborious process to transport and set up the tables. The process may require the tables to be lifted free of the cart by two or more people, or if stored vertically in a closet, requires the tables to be moved one at a time.

Examples of patents related to the present invention, each of which are herein incorporated by reference for their supporting teachings, are as follows:

U.S. Pat. No. 3,655,212, to Krass et al., teaches about a self-supporting cart which includes a base frame carrying a front pair of laterally spaced roller means and a rear pair of laterally spaced roller means, and a load-receiving frame pivoted to the front end portion of the base frame. The bottom ends of a pair of elongated bracing members are pivotably connected to the rear end of the base frame and the upper ends thereof are pivotably connected to a pair of slide members slidable along the load-receiving frame. A pair of retractable pins operated by a pair of squeeze handles selectively lock the slide members in any one of a number of different positions along the load-receiving frame. The base frame has a U-shaped configuration opening to the rear of the cart.

U.S. Pat. No. 3,873,118, to Takagi, comprises a manual carrier, a front wheel support U-shaped arm that is pivotally mounted on the underside of the carrier table, and at one portion of said U-shaped arm a support arm is connected therewith. By extending said U-shaped arm, the carrier is used as a three-wheeled carrier and by adjusting said support arm the carrier table is convertible from an inclined position to a horizontal position or vice versa. Further, when said U-shaped arm is laid away, the carrier is used as a two-wheeled carrier.

U.S. Pat. No. 4,488,733, to Hellsten, teaches about a hand-operated, wheeled carrier for transporting large-sized plates, such as building boards, comprises a stand including a generally upright frame structure mounted on an elongated base structure having along one longitudinal side thereof brackets, on which a small number of plates to be carried may be rested on edge in a position leaning against the frame structure, a hook member and strap connected to the stand being provided to releasably retain the plates in such a position. Substantially midway between its ends and close to the plate brackets the base structure has a single, relatively large supporting wheel adapted to take the entire load, when the stand is to be moved, the stand then being balanced on the single wheel by the operator. A pair of casters, one near each end of the base structure, provide additional supports for keeping the stand in a stable position when at rest, the casters being located further away from the plate brackets than the supporting wheel. The frame structure of the stand includes a substantially horizontal and easily accessible handle bar of considerable length.

U.S. Pat. No. 4,435,115 to Orstad et al., teaches about a dolly for lifting and carrying dead sows and the like from and in confined spaces respectively. A platform on castors with a vertical back has a removable pulley, at their adjoinment, through which a cable first pulls the sow horizontally onto the platform and then vertically, after the pulley is removed, along the vertical back. The cable is pulled by a winch attached to the rear side of the vertical back.

U.S. Pat. No. 4,793,624, to Mace, teaches of a cart that is used to transport planar materials such as plywood and drywall through a person size doorway. The transported material is in an upright position supported by a removable vertical side support on a planar elongated frame. The planar elongated frame is larger in the center and tapers inwardly at each end to about half its central width. The central portion of the cart has two large wheels on a transverse axle while the tapered ends each have central casters. The removable vertical side support has three receivers in the supper surface of the planar elongated frame. One of each of the three members of the vertical side support is received in each of the middle and tapered sections, respectively. The three members meet and form an arched shape with an off-set central member.

U.S. Pat. No. 5,244,221, to Ward, teaches about a multi-use handtruck or dolly apparatus and more particularly, a handtruck useable in the commercial building construction industry. It is capable of being used in both a vertical mode as well as a horizontal mode. When used in its vertical mode, it is capable of carrying up to five doors or other large objects. When used in its horizontal mode, it serves as a sturdy planar work support surface and permits a workman to perform required tasks thereon. Additionally, the apparatus can be joined with another like apparatus and present a much larger horizontal planar work surface. The apparatus includes telescopic frame members which permit accommodation of various length loads. Further, a plurality of swivel casters are provided which allow full rotational movement of the apparatus when used in its horizontal mode.

U.S. Pat. No. 5,788,251, to Johnson, teaches about a table lift and transporter comprising a frame provided with wheels or casters for easy movement on a floor or pavement, a super structure mounted on the frame for movement between a first position closer to the frame and a second position further from the frame, such super structure having a clamping device for engaging the under structure of a table when the super structure is moved to said second position. The frame has rounded ends facilitating rotating it from a normal horizontal position to a vertical position.

U.S. Pat. No. 5,820,145, to Osowski, teaches about a cart for transporting doors, tables, plywood and other sheet material of various sizes consisting of: an axle with two wheels journalled on opposite ends of an axle. A V-channel is anchored to the axle perpendicular to it, into which the center of the long side of a table or sheathing is inserted and leaned against an upright standard which is anchored to the axle perpendicular to the axle and the V-channel. The loaded material is then held in an upright position against the upright standard by a retaining hook that slides freely up and down the upright standard resting on the top edge of the loaded material and hooking over it. The combination of V-channel, upright standard, and retaining hook allows the cart to adjust to a wide range of different size material without the need of modification. Because the wheels are in the center of the load, the whole unit consisting of cart and loaded material is easily maneuvered and is very stable.

U.S. Pat. No. 5,871,219, to Elliott, teaches about a table dolly apparatus and method for using same which allows folded tables to be vertically stacked in two adjacent side-by-side columns, such that the planar folded tables are included slightly from horizontal to reduce the dolly's transverse width such that is can pass through doorways.

U.S. Pat. No. 6,053,515, to Kelly, teaches about a carrier which comprises a carrier box formed with a rectangular base plate with side edges and remote and near edges and with a plurality of plates including a remote end plate extending upwardly from the remote edge of the base plate at a right angle with respect thereto having a generally rectangular configuration and with a near end plate and a hinge coupling the lower end of the near end plate to the near edge of the base plate and with a pair of side plates with a linear lower edge positioned adjacent the side edges of the base plate with parallel hinges coupled with respect thereto. A tubular frame assembly includes parallel sides having upper extents coupled by rivets to the lower surface of the base plate adjacent to the side edges and extending rearwardly thereof with a generally u-shaped extension extending rearwardly of the parallel sides. A pair of wheels are mounted for rotational movement and about a common axis of rotation beneath the base plate adjacent to the remote end. A pair of casters with rotatable wheels are provided for rotation beneath the side rails with each of the wheels mounted for swivel movement about a vertical axis.

U.S. Pat. No. 6,086,310, to Lujan, III et al., teaches about a four-wheeled multipurpose handtruck which is especially adapted to transport a cylindrical object such as a beer keg. A cradle-like frame nests the beer keg and a metal collar secures the keg to the frame. The handtruck employs a curved frame construction which enhances leverage when loading or unloading a keg. Movable rear wheels allow the handtruck to assume a four-wheeling horizontal transport position or the rear wheels may be collapsed for standard two-wheeled transport.

U.S. Pat. No. 2,881,865, to Lewis, teaches about a handtruck which is a combination of a wheeled base, and elongated frame extending upwardly of said base, winch means on said frame, a load supporting carriage slidable mounted on said frame, and a cable secured to and between said carriage and manually actuatable winch means for elevating said carriage, said winch means including a cable winding drum and a crank for said drum, said crank being shiftable with respect to the axis of said drum, said frame having a plurality of locking abutments engageable with said crank, said crank being biased toward said abutments.

Thus, there is a need for a cart that allows for the transportation and the storage of round tables that are in a vertical storage position.

### SUMMARY OF THE INVENTION

A feature of the invention is to provide a round table cart for moving round tables along the ground. Uniquely, the invention has a first and second side support, each having a bottom, top, front and rear location. There is a ramp, connected between the first and second side supports at the bottom and front location. A pair of pivot wheels are connected to the first and second side supports proximate the ramp. A pair of swivel wheels, connected to the first and second side supports near the rear location. A support bar, coupled between the first and second side supports proximate the pair of swivel wheels. The table cart specifically is designed to have a first position that positions the ramp and the pair of pivot wheels on the ground, while maintaining the pair of swivel wheels off of the ground so that a round table can be loaded onto the round table cart. A second position of the cart comprises a position where the ramp is above the ground and the pair of pivot and swivel wheels are positioned upon the ground for easy movement of the round table cart across the ground.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a side view of the preferred embodiment in the loading position.

FIG. 2 is a side view of the preferred embodiment in the transport position.

FIG. 3 is a front view of the preferred embodiment.

It is noted that the drawings of the invention are not to scale. The drawings are merely schematic representations, not intended to portray specific parameters of the invention. The drawings are intended to depict only selected embodiments of the invention, and therefore should not be considered to be limiting the scope of the invention. The invention will be described with additional specificity and detail through the use of the accompanying drawings. Like numbering between figures represent like elements.

### DETAILED DESCRIPTION OF THE DRAWINGS

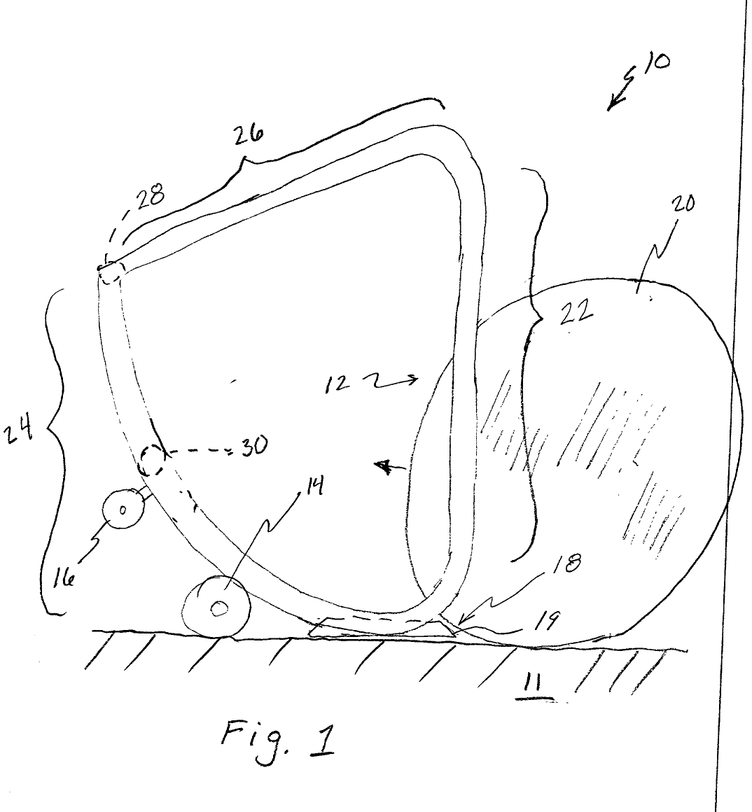

Illustrated in FIG. 1 is a side view of an embodiment of a cart 10 for the vertical transport and storage of round tables. Specifically, there is a cart 10 in a position as shown relative to a floor 11. The cart 10 has a frame 12 to which is attached a pivot wheel 14, a swivel wheel 16, and a ramp 18. Ramp 18 would typically, though not necessarily, have a beveled edge 19, to facilitate loading. The figure illustrates the cart 10 tilted forward with the ramp 18 on contact with the floor 11. This position constitutes a loading position, wherein table 20 is illustrated as being loaded.

The frame 12 is further comprised of a front tube 22, a rear tube 24, and a top tube 26. Additionally, the frame 12 also contains a top cross support 28 and a middle cross support 30. It is noted that front tube 22 is typically, though not necessarily, a straight section of tubing. In a similar fashion, top tube 26 is typically a straight section of tubing; while rear tube 24 would generally be shaped in an arc.

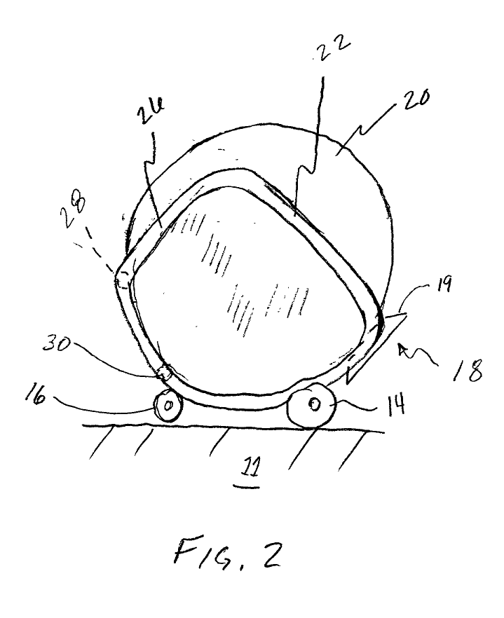

Referring to FIG. 2, a side view of the preferred embodiment in a transport position is shown. Specifically, this position is achieved when pivot wheel 14 and swivel wheel 16 are simultaneously in contact with the floor 11. It is noted that in this position ramp 18 is not in contact with the floor 11. Further, the illustration shows the table 20 firmly situated in the cart 10. Specifically, the cart 10 is supported by the now elevated ramp 19 and the cross support members 28 and 30.

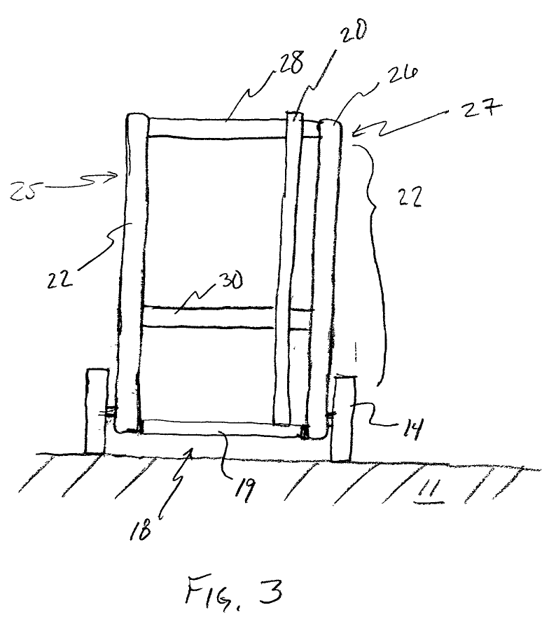

FIG. 3 is a front view of the preferred embodiment. Specifically, the cart 10 consists of the frame 12, to which pivot wheel 14, swivel wheel 16, and ramp 18 are attached. Further, the table 20 rests on top cross support tube 28, middle cross support tube 30, and ramp 18. It is noted that one complete connection of tubes 22, 24 and 26 forms a first and second side support structure 25 and 27. The side structure 25 and 27 forming proximate physical landmarks of a bottom, top, front and rear location.

### Operation of the Preferred Embodiment

It is noted that one skilled in the art would easily understand the operation of the vertical table storage and transport cart 10. A typical loading operation would require the cart 10 to be brought into the vicinity of the tables 20, which require storage. To begin the loading operation, the cart 10 is tilted forward into the loading position, which occurs when the pivot wheel 14 and the ramp 18 are simultaneously in contact with the floor 11. The table 20 would then be stood on end and rolled over the beveled edge 19 of ramp 18 and into the cart 10. Beveled edge 19, if present, serves to allow the table 20 to pass more easily over the ramp 18. This loading sequence would be repeated until the cart is loaded. After loading, the cart 10 is easily tilted back into the transport position. The transport position is achieved when pivot wheel 14 and swivel wheel 16 are simultaneously in contact with the floor 11. In this position it is an easy matter to move the cart with its loaded tables into a storage closet.

### Remarks about the Preferred Embodiment

It is easily seen that the process of retrieving stored tables follows the reverse of the storage process. It should also be noted that in either the loading or the transport positions, the tables are securely cradled by top cross support tube 28, middle cross support tube 30, and ramp 18. It is further noted that the preferred embodiment provides an easy method for the transportation and storage of several tables, thus enabling a reduction in the laborious set up process. The labor savings are realized by the ability to transport more than one table at a time, using a few as one person. Thus, an entire social hall, for example, can be set up in minimal time.

### Variations of the Preferred Embodiment

One skilled in the art would be capable of making many obvious design changes which would stay within the scope of the invention disclosed in this application. It is noted that ramp 18 is illustrated has having beveled edge 19. However, it is understood that the ramp 18 does not need bevel 19 to function. For example, if the ramp were of this material no bevel would be required. Furthermore, the bevel could be a rounded edge. Further, ramp 18 could be constructed in a variety of shapes, or mounted at various angles or positions. For example, the ramp 18 could be constructed in an overall wedge shape. Additionally, swivel wheel 16, could be mounted to the frame 12 with or without a swiveling action. The Frame 12 is illustrated as having two cross supports, tubes 28 and 30. However, the frame 12 could also be constructed using any number of supporting cross members, in various positions, to accommodate differing table designs and dimensions.

Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function, manner of operation, assembly, and use may be made without departing from the principles and concepts set forth herein.

What is claimed is:

1. A round table cart for moving round tables along the ground, comprising:
a) a first and second side support, each having a bottom, top, front and rear location;
b) a ramp, connected between the first and second side supports at the bottom and front location;
c) a pair of pivot wheels, connected to the first and second side support proximate the ramp;
d) a pair of swivel wheels, connected to the first and second side supports near the rear location;
e) a support bar, coupled between the first and second side supports proximate the pair of swivel wheels; and
f) the table cart having:
1) a first position that positions the ramp and the pair of pivot wheels on the ground, while maintaining the pair of swivel wheels off of the ground so that a round table can be loaded onto the round table cart; and
2) a second position that positions the ramp above the ground and the pair of pivot and swivel wheels are positioned upon the ground for easy movement of the round table cart across the ground.

2. The round table cart of claim 1, wherein the first and second side supports comprise a tubular frame having a front tube, a rear tube, and a top tube that are coupled together.

3. A round table cart designed to move round table across ground, comprising:
a) a frame to support a round table thereon;
b) a first and second pair of wheels, attached to the cart;
c) a ramp, attached to the frame;
d) the round table cart having:
1) a first position that positions the ramp and the first pair of wheels on the ground, while maintaining the second pair of wheels off of the ground, so that a round table can be loaded onto the round table cart by being rolled over the ramp; and
2) a second position that has the ramp located above the ground and the first and second pairs of wheels positioned upon the ground for easy movement of the round table cart across the ground.

4. A cart for moving round tables on ground, comprising:
a) a frame;
b) a first and second set of wheels, attached to the frame;
c) means for loading round tables onto the cart when the first set of wheels are off of the ground, and for moving the cart around when the first and second set of wheels are on the ground.
